(19) United States
(12) Patent Application Publication
(10) Pub. No.: US 2015/0263585 A1
(43) Pub. Date: Sep. 17, 2015

(54) FASTENER COUPLING RADIALLY INSIDE A STATOR ASSEMBLY

(71) Applicant: Seagate Technology LLC, Cupertino, CA (US)

(72) Inventors: Hans Leuthold, Santa Cruz, CA (US); Lynn Bich-Quy Le, San Jose, CA (US); Chris M. Woldemar, Santa Cruz, CA (US)

(73) Assignee: Seagate Technology LLC, Cupertino, CA (US)

(21) Appl. No.: 14/210,146

(22) Filed: Mar. 13, 2014

(51) Int. Cl. H02K 7/00; G11B 19/20

(52) U.S. Cl. CPC H02K 7/003; G11B 19/2009

(57) ABSTRACT

Provided herein is an apparatus, including a stator assembly and a hub configured to rotate relative to the stator assembly. The hub comprises a magnet radially outside the stator assembly. The apparatus further includes a fastener coupling radially inside the stator assembly.

### BACKGROUND

An electric motor may use stators, magnets, and/or coils to rotate an object. For example, a motor may rotate data storage disks used in a disk drive storage device. The data storage disks may be rotated at high speeds during operation using the stators, magnets, and/or coils. For example, magnets and coils may interact with a stator to cause rotation of the disks relative to the stator.

In some cases, electric motors are manufactured with increasingly reduced sizes. For example, in order to reduce the size of a disk drive storage device, the size of various components of the disk drive storage device may be reduced. Such components may include the electric motor, stator, magnets, and/or coils. The precision at which the components are manufactured can affect the reliability and performance of the electric motor.

### SUMMARY

Provided herein is an apparatus, including a stator assembly and a hub configured to rotate relative to the stator assembly. The hub comprises a magnet radially outside the stator assembly. The apparatus further includes a fastener coupling radially inside the stator assembly.

These and other features and aspects may be better understood with reference to the following drawings, description, and appended claims.

### DRAWINGS

FIG. 1 provides a cross-sectional side view of a spindle motor for a hard disk drive, according to one aspect of the present embodiments.

FIG. 2 provides a cross-sectional side view of an exemplary fastener coupling and a first clamp design, according to one aspect of the present embodiments.

FIG. 3 provides a cross-sectional side view of an exemplary fastener coupling and a second clamp design, according to one aspect of the present embodiments.

FIG. 4 provides a top view of an exemplary clamp coupled to a fastener coupling, according to one aspect of the present embodiments.

FIG. 5 provides a cross-sectional side view of an exemplary fastener coupling and a stator assembly, according to one aspect of the present embodiments.

FIG. 6 illustrates an exemplary diagram of a hard drive according to one aspect of the present embodiments.

### DESCRIPTION

Before particular embodiments are described in greater detail, it should be understood by persons having ordinary skill in the art that the concepts presented herein are not limited to the particular embodiments described and/or illustrated herein, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood by persons having ordinary skill in the art that the terminology used herein is for the purpose of describing particular embodiments, and the terminology is not intended to be limiting. Unless indicated otherwise, ordinal numbers (e.g., first, second, third, etc.) are used to distinguish or identify different elements or steps in a group of elements or steps, and do not supply a serial or numerical limitation on the elements or steps. For example, “first,” “second,” and “third” elements or steps need not necessarily appear in that order, and the elements or steps need not necessarily be limited to three elements or steps. It should also be understood that, unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” and the like are used for convenience and are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

Unless defined otherwise, all technical and scientific terms used herein have the same meaning as commonly understood by persons of ordinary skill in the art.

Typically, the bolt and bolt circle are located above the stator winding of an electric motor. As devices are made smaller, the bolt circle approaches the electromagnetic portion of the motor and reduces the space available for the electromagnetic portion of the motor. For example, storage devices with heights of 5 mm or 7 mm may have motors that are reduced in height and/or other dimensions. This reduction in space can make designing the electromagnetic portion of the motor difficult and can create issues with pure tones (PDT). One solution might be development of a new screwless technology. However, a new screwless technology would be untested, thereby making the new screwless designs a riskier design choice with increased development time.

Embodiments described herein may include a fastener coupling or fastener (e.g. bolt, screw, etc.) positioned inside (e.g., at an inside radius) relative to various electromagnetic portions (e.g., a stator assembly) of a motor. In some embodiments, the fastener coupling is configured to provide additional height budget to electromagnetic portions of the motor. In some embodiments, the fastener coupling (e.g., fastener circle) is positioned at an inner diameter between the stator coil inner diameter and the seal outer diameter thereby allowing (e.g., simultaneously) for a more compact motor design. Embodiments thereby allow for an increased height budget for electric motor components while allowing smaller components to be used. Embodiments further provide for a more efficient motor. In some embodiments, the fastener coupling may be a fastener circle or bolt circle. Embodiments may include a fixed shaft motor or rotating shaft motor.

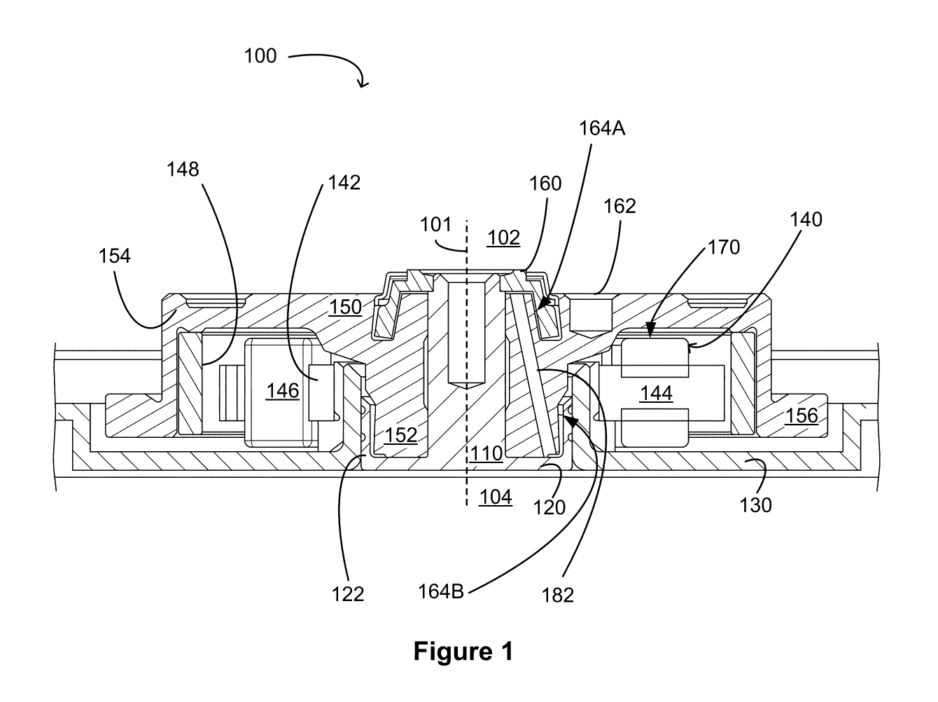

FIG. 1 provides a cross-sectional side view of a spindle motor for a hard disk drive, according to one aspect of the present embodiments. FIG. 1 provides cross-sectional view of a motor (e.g., FDB motor) including parts or components that are fused according to some embodiments, as described herein. However, it should be understood that the particular embodiments provided in FIG. 1 are merely examples, and the particular embodiments are not limiting.

The FDB motor 100 in FIG. 1 includes a stationary component and a rotatable component positioned for relative rotation about a bearing system. With respect to the stationary component, the stationary component may include a shaft 110 extending from a first axial end 102 of the FDB motor 100 to a second axial end 104 of the FDB motor 100, through which the shaft 110 passes a centerline axis 101 of the FDB motor 100. The shaft 110 may be coupled to a thrust cup or cup 120 at the second axial end 104 of the FDB motor 100, which cup 120, in turn, may be coupled to a base 130 through a wall 122 of the cup 120. The stationary component may further include a stator assembly 140 coupled to the base 130, which stator assembly 140 may include a yoke 142, a plurality of stator teeth 144, and a plurality of field coils 146 singly disposed on the plurality of stator teeth 144. Adhesive bonds may be used to couple the foregoing components, but coupling may also be accomplished with epoxy, welds, or fasteners, as desired. One or more sub-components (e.g., shaft 110) of the stationary component may be coupled to a housing for the FDB motor 100, or a housing component (e.g., top cover), which may significantly improve structural stiffness of the system while compromising little in axial space.

With respect to the rotatable component of the FDB motor 100 in FIG. 1, the rotatable component may include a sleeve-hub assembly 150 having a sleeve 152 sub-component coupled to a hub 154 sub-component. As shown, the sleeve-hub assembly 150 may be an integral sleeve-hub assembly 150 having a sleeve 152 portion and a hub 154 portion. The sleeve 152 of the sleeve-hub assembly 150 may be rotatably fitted within the cup 120 such that the cup wall 122 of the cup 120 extends over a substantial axial length of the sleeve 152, including over at least 20% to 80% of the axial length of the sleeve 152, which may function to minimize angular displacement of the sleeve-hub assembly.

The sleeve 152 may include a cylindrical bore through its center in which the shaft 110 may be fitted. The hub 154 of the sleeve-hub assembly 150 may include a hub flange 156 configured to support one or more disks (e.g., magnetic recording media) for rotation. The hub 154 may further include a back iron and magnet 148 coupled to the hub 154, which back iron and magnet 148 cooperates with the stator assembly 140 to induce rotation of the hub 154 and the disk pack. Adhesive bonds may be used to couple the foregoing components, but coupling may also be accomplished with epoxy, welds, or fasteners, as desired.

The sleeve-hub assembly 150 may further include a recirculation channel 182 which is part of a recirculation system for the lubricating fluid (e.g., lubricating oil), wherein the recirculation system is primarily positioned between the stationary component and the rotatable component, and wherein the recirculation system includes the bearing system and a fluid circuit of FDB motor 100. As shown in FIG. 1, the recirculation channel 182 may be configured such that the recirculation channel 182 is angled or not parallel to the shaft 110 and/or centerline axis 101. In such a configuration, the recirculation channel 182 near the first axial end 102 of the FDB motor 100 may be at an inner radius and the recirculation channel 182 near the second axial end 104 of the FDB motor 100 may be at an outer radius, wherein the inner radius and the outer radius represent relative radial distances from the shaft 110 and/or centerline axis 101.

In some embodiments, the recirculation channel 182 may be configured such that the recirculation channel 182 is parallel to the shaft 110 and/or centerline axis 101. In such a configuration, the recirculation channel 182 near the first axial end 102 of the FDB motor 100 and the recirculation channel 182 near the second axial end 104 of the FDB motor 100 are at substantially equal radial distances from the shaft 110 and/or centerline axis 101.

A limiter cap or top cap 160 may be employed to limit axial movement of the rotatable component with respect to the stationary component. In the example shown, the facing surfaces of the limiter 160 and the sleeve-hub assembly 150 may limit the axial movement. In some embodiments, top cap 160 is attached to, or in contact with, at least one of the shaft 110 and a top cover (not shown).

FDB motor 100 may include seals 164A-B. In some embodiments, seal 164A may be a pump seal formed by lubricant between the limiter 160 and the hub assembly 150. In some embodiments, seal 164B may be a capillary seal formed by lubricant between sleeve-hub assembly 150 and cup 120. Seals 164A-B may be oil-air interfaces.

FDB motor 100 may further include a fastener coupling 162 for coupling of one or more components (e.g., a clamping mechanism) and applying pressure to the one or more components (not shown) for holding disks. In some embodiments, fastener coupling 162 is between an outer diameter of seals 164 and inner diameter of coils 146. In some embodiments, the fastener coupling 162 is a bolt circle and configured for coupling of a fastener (e.g., a screw, bolt, etc.). The fastener coupling 162 may extend axially below a top surface 170 of stator assembly 140.

In some embodiments, the fastener coupling 162 is radially inside relative to the stator assembly 140. In other words, the fastener coupling 162 may be radially inside of the coils 146. For example, fastener coupling 162 is radially inside relative to the stator windings or coils 146 between the sleeve 152 and the stator assembly 140. As another example, the fastener coupling 162 may be between an axis of rotation of the motor and a stator assembly as viewed from a top view or plan view of the motor 100.

The fastener coupling 162 thereby allows a fastener to be more centrally located relative to the axis of rotation (e.g., centerline axis 101) of the motor 100. A fastener may thus be coupled closer to the center of the hub assembly 150 and closer to shaft 110.

Therefore, the fastener coupling 162 or fastener circle and a fastener (e.g., screw, bolt, etc.) are positioned or located in an inner diameter with respect to conventional designs. In some embodiments, for example, the fastener coupling 162 is positioned between the stator assembly 140 inner diameter and the seal 164A or seal 164B outer diameter. Embodiments thereby provide an increase in the height budget (thus allowing a larger stator assembly 140), thereby providing a more efficient motor. As a result, embodiments may have an increased area for electromagnetic components (e.g., stator assembly), while at the same time reducing overall motor size. For example, the increase in area for a stator assembly may allow for more stator windings or coils to be used in a smaller motor. Embodiments may allow use of conventional disk clamping mechanisms (e.g., screw and bolt circle) while avoiding new, higher risk screwless disk clamp designs.

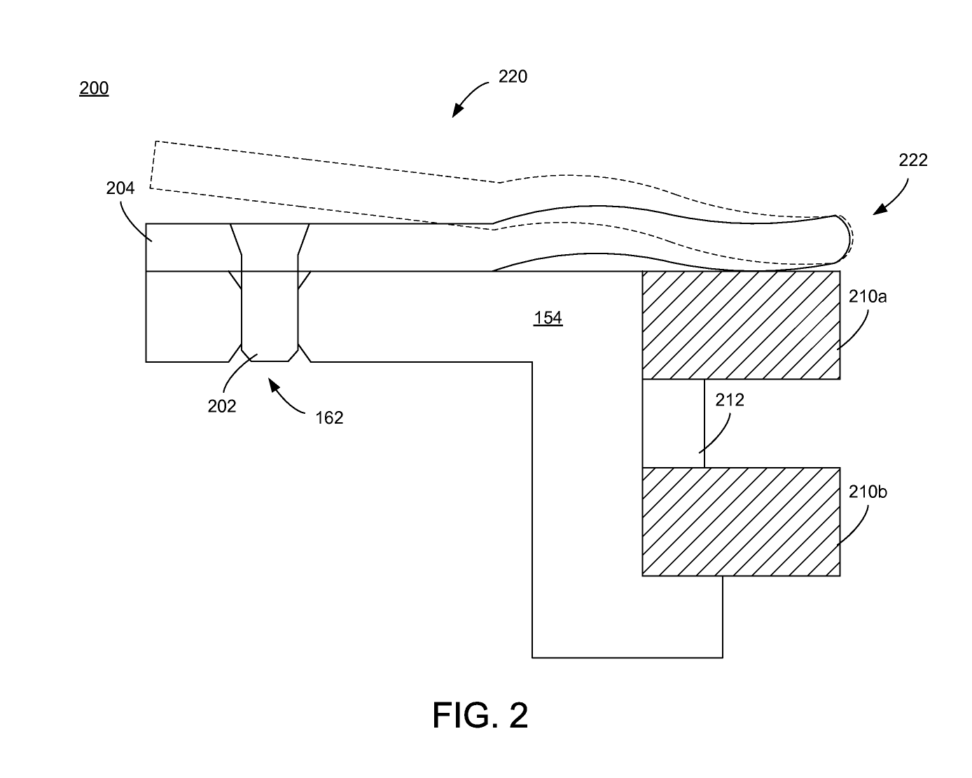

FIG. 2 provides a cross-sectional side view of an exemplary fastener coupling and a first clamp design, according to one aspect of the present embodiments. Diagram 200 includes a hub 154, disks 210A-B, a spacer 212, a fastener 202, and a clamp 204. Disks 210A-B may be configured for data storage as described herein. The spacer 210 is configured to hold the disks 210A-B apart and provide space for accessing data on the disk 210B. In some embodiments, the disks 210A-B are coupled to the hub 154 with the spacer 212 is in between the two disks 210A-B. The clamp 204 is configured to hold the disks 210A-B and the spacer 212 in place on the hub 154. Embodiments may support more or fewer disks.

Hub 154 includes a fastener coupling 162. In one embodiment, the fastener coupling 162 is positioned between the seal (not shown) and the stator (not shown). This positioning of the fastener coupling 162 is advantageous because it provides enough spacing for the fastener 202 (e.g., a screw, bolt, etc.) mounting in smaller motor designs. For example, the fastener coupling 162 may be configured for the coupling of screw configured for retaining a disk clamp.

The fastener 202 (e.g., a screw, bolt, etc.) may apply a lever action to the clamp 204 thereby holding the clamp 204 in place and allowing the clamp 204 to apply pressure to an object attached to the motor (e.g., the disk 210A, the disk spacer 212, etc.). The fastener 202 (e.g., screw) may bend or distort the clamp 204 thereby allowing the clamp 204 to apply pressure to another component (e.g., the disks 210A-B and the spacer 212).

In some embodiments, the clamp 204 may be positioned in an initial position 220 and then coupled to the hub 154 via the fastener coupling 162 and fastener 202 thereby positioning the clamp 204 into a clamped position 222. The clamp 204 may be deformed downwards in such a way that the fastener 202 holds it in the clamped position 222. The fastener 202 may thus apply torque to the disk 210A via the clamp 204. In some embodiments, the clamp 204 is annular in shape or a clamping ring and axis symmetric to the axis of rotation of the motor. The clamp 204 may thus apply an axial force to the disk 210A.

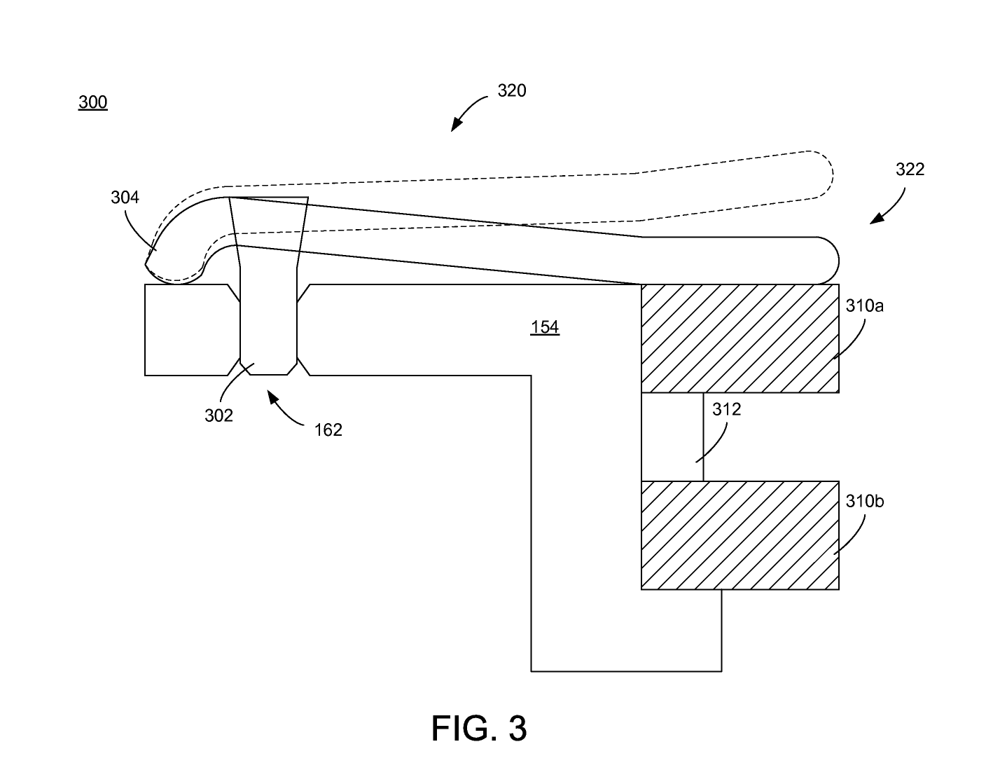

FIG. 3 provides a cross-sectional side view of an exemplary fastener coupling and a second clamp design, according to one aspect of the present embodiments. Diagram 300 includes a hub 154, disks 210A-B, a spacer 212, a fastener 302, and a clamp 304.

Clamp 304 may be positioned in an unclamped position 320 and then coupled to the hub 154 via a fastener coupling 162 and fastener 302 thereby positioning the clamp 304 into a coupled position 322. The coupling of the clamp 304 to the hub 154 may deform the clamp 304. The clamp 304 may thus apply a torsional moment to the disk 210A (e.g., via clamp 304). In some embodiments, the fastener coupling 162 may be configured for the fastener 302 (e.g., a screw, bolt, etc.) to be coupled to the shaft of a rotating shaft motor.

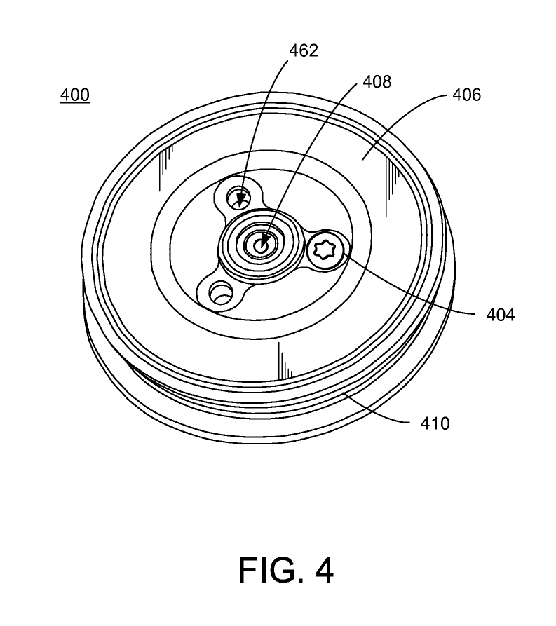

FIG. 4 provides a top view of an exemplary clamp coupled to a fastener coupling, according to one aspect of the present embodiments. Motor assembly 400 includes a fastener coupling 462, a fastener 404, a clamping mechanism 406, a shaft 408, and surface 410. The fastener 404 is coupled to the fastener coupling 462. The components of the motor assembly 400 may rotate about the shaft 408 (e.g., shaft 110). The fastener 404 couples the clamping mechanism 406 to a motor assembly (e.g., to hub assembly 150 of motor 101). The clamping mechanism 406 may be configured to couple and hold one or more disks (e.g., disks 210A-B) to a motor assembly (e.g., motor 100). Surface 410 is configured for attachment of objects to be rotated by the motor assembly (e.g., disks 210A-B). In some embodiments, the clamping mechanism 406 may apply pressure to hold disks (e.g., disks 210-B) to the surface 410.

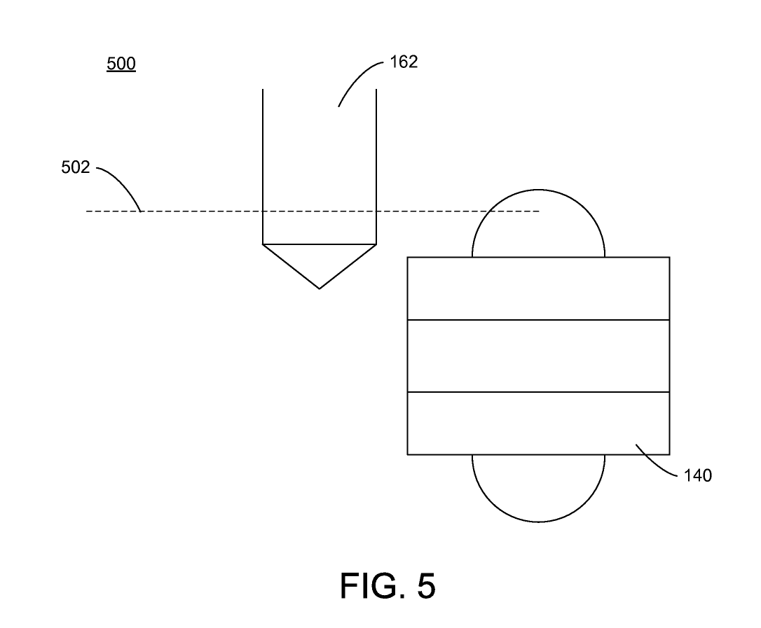

FIG. 5 provides a cross-sectional side view of an exemplary fastener coupling and a stator assembly, according to one aspect of the present embodiments. Diagram 500 includes a horizontal plane 502, a fastener coupling 162, and a stator assembly 140. FIG. 5 depicts a portion of the fastener coupling 162 extending into the horizontal plane 502 of a portion of the stator assembly 140. For example, fastener coupling 162 may extend axially below a top surface (e.g., top surface 170) of stator assembly 140. A portion of the fastener coupling 162 may thus be between a shaft (not shown) of the motor and the stator assembly 140.

In some embodiments, the moving of the fastener coupling 162 (e.g., or a bolt and bolt circle) toward the inner diameter of the motor allows the fastener coupling 162 to extend below the stator assembly 140 instead of being limited by the height of the stator assembly 140. Thus in some embodiments, a reduction in the size of stator assembly 140 might not be needed in order to make room for fastener coupling 162.

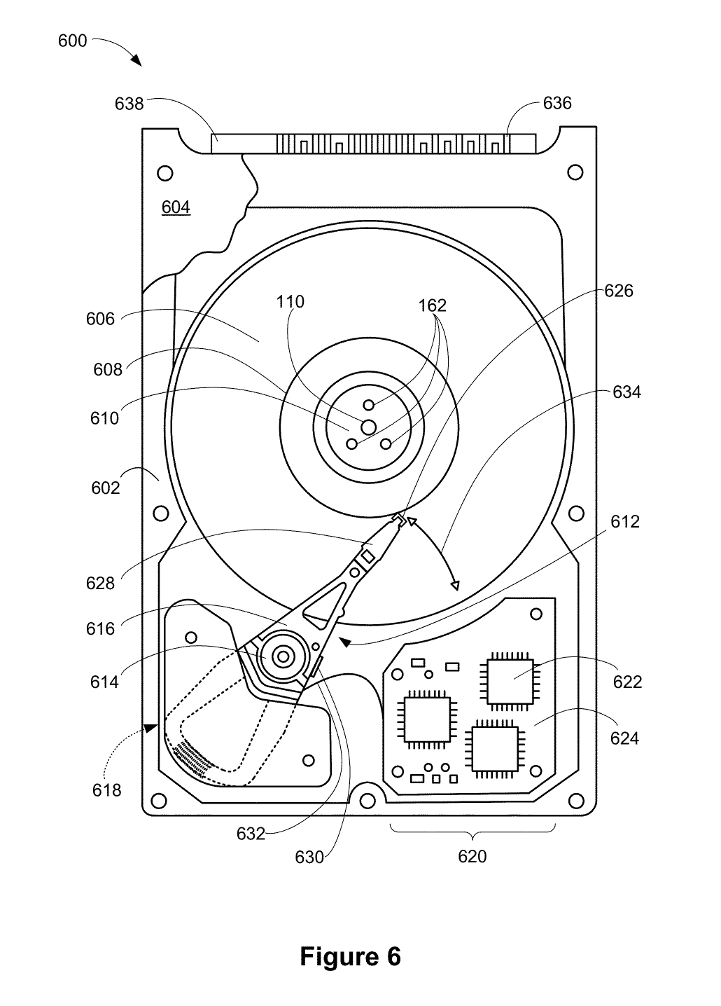

FIG. 6 illustrates an exemplary diagram of a hard drive according to one aspect of the embodiments. FIG. 6 depicts a plan view of a data storage device in which embodiments as described may be implemented is shown. A disk drive 600 generally includes a base plate 602 and a cover 604 that may be disposed on the base plate 602 to define an enclosed housing for various disk drive components. The disk drive 600 includes one or more data storage disks 606 of computer-readable data storage media. Typically, both of the major surfaces of each data storage disk 606 include a plurality of concentrically disposed tracks for data storage purposes. Each data storage disk 606 is mounted on a hub 608, which in turn is rotatably interconnected with the base plate 602 and/or cover 604. Multiple data storage disks 606 are typically mounted in vertically spaced and parallel relation on the hub 608. A spindle motor 610 rotates the data storage disks 606. The spindle motor 610 may include shaft 110 and one or more of fastener coupling 162.

The disk drive 600 also includes an actuator arm assembly 612 that pivots about a pivot bearing 614, which in turn is rotatably supported by the base plate 602 and/or cover 604. The actuator arm assembly 612 includes one or more individual rigid actuator arms 616 that extend out from near the pivot bearing 614. Multiple actuator arms 616 are typically disposed in vertically spaced relation, with one actuator arm 616 being provided for each major data storage surface of each data storage disk 606 of the disk drive 600. Other types of actuator arm assembly configurations could be utilized as well, an example being an “E” block having one or more rigid actuator arm tips, or the like, that cantilever from a common structure. Movement of the actuator arm assembly 612 is provided by an actuator arm drive assembly, such as a voice coil motor 618 or the like. The voice coil motor 618 is a magnetic assembly that controls the operation of the actuator arm assembly 612 under the direction of control electronics 620.

The control electronics 620 may include a plurality of integrated circuits 622 coupled to a printed circuit board 624. The control electronics 620 may be coupled to the voice coil motor assembly 618, a slider 626, or the spindle motor 610 using interconnects that can include pins, cables, or wires (not shown).

A load beam or suspension 628 is attached to the free end of each actuator arm 616 and cantilevers therefrom. Typically, the suspension 628 is biased generally toward its corresponding data storage disk 606 by a spring-like force. The slider 626 is disposed at or near the free end of each suspension 628. What is commonly referred to as the read/write head (e.g., transducer) is appropriately mounted as a head unit (not shown) under the slider 626 and is used in disk drive read/write operations. The head unit under the slider 626 may utilize various types of read sensor technologies such as anisotropic magnetoresistive (AMR), giant magnetoresistive (GMR), tunneling magnetoresistive (TuMR), other magnetoresistive technologies, or other suitable technologies.

The head unit under the slider 626 is connected to a preamplifier 630, which is interconnected with the control electronics 620 of the disk drive 600 by a flex cable 632 that is typically mounted on the actuator arm assembly 612. Signals are exchanged between the head unit and its corresponding data storage disk 606 for disk drive read/write operations. In this regard, the voice coil motor 618 is utilized to pivot the actuator arm assembly 612 to simultaneously move the slider 626 along a path 634 and across the corresponding data storage disk 606 to position the head unit at the appropriate position on the data storage disk 606 for disk drive read/write operations.

When the disk drive 600 is not in operation, the actuator arm assembly 612 is pivoted to a “parked position” to dispose each slider 626 generally at or beyond a perimeter of its corresponding data storage disk 606, but in any case in vertically spaced relation to its corresponding data storage disk 606. In this regard, the disk drive 600 includes a ramp assembly (not shown) that is disposed beyond a perimeter of the data storage disk 606 to both move the corresponding slider 626 vertically away from its corresponding data storage disk 606 and to also exert somewhat of a retaining force on the actuator arm assembly 612.

Exposed contacts 636 of a drive connector 638 along a side end of the disk drive 600 may be used to provide connectivity between circuitry of the disk drive 600 and a next level of integration such as an interposer, a circuit board, a cable connector, or an electronic assembly. The drive connector 638 may include jumpers (not shown) or switches (not shown) that may be used to configure the disk drive 600 for user specific features or configurations. The jumpers or switches may be recessed and exposed from within the drive connector 638.

As such, as provided herein is an apparatus, including a stator assembly and a hub configured to rotate relative to the stator assembly. The hub comprises a magnet radially outside the stator assembly. The apparatus further includes a fastener coupling radially inside the stator assembly and configured to couple a rotatable component (e.g., a disk, etc.). In some embodiments, the stator assembly is a portion of a fixed shaft motor. In some embodiments, the stator assembly is a portion of a rotating shaft motor. In some embodiments, the fastener coupling is configured for coupling of a fastener and a clamp. In some embodiments, a portion of the fastener coupling extends into a horizontal plane of the stator assembly. In some embodiments, the fastener coupling is more centrally located relative to a shaft of a motor assembly than the stator assembly. In some embodiments, the fastener coupling is configured for coupling of a clamp via a screw.

Also provided herein is an apparatus, including a stationary component including a stator assembly, a rotatable component configured to rotate relative to the stationary component, and a fastener coupled to the rotatable component radially inside the stator assembly. In some embodiments, the rotatable component is a portion of a fixed shaft motor. In some embodiments, the rotatable component is a portion of a rotating shaft motor. In some embodiments, the fastener is configured for coupling of a clamp. In some embodiments, the apparatus further comprises a first disk, a second disk, and a spacer between the first disk and the second disk. In some embodiments, a portion of the fastener extends into a horizontal plane of the stator assembly. In some embodiments, the fastener is radially inside of the stator assembly of the stationary component.

Also provided herein is an apparatus, including a stator assembly including stator windings, a hub configured to rotate relative to the stator assembly, and a fastener circle extending axially below a top surface of the stator assembly. The fastener circle is radially inside the stator windings. In some embodiments, the stator assembly is radially inside of the hub. In some embodiments, the fastener circle is configured for coupling of a fastener and a clamp. In some embodiments, a portion of the fastener circle extends into a horizontal plane of the stator windings. In some embodiments, the fastener circle is configured for coupling of a clamp via a screw. In some embodiments, the fastener circle is radially between a seal and the stator assembly.

While particular embodiments have been described and/or illustrated, and while these embodiments and/or examples have been described in considerable detail, it is not the intention of the applicant(s) to restrict or in any way limit the scope of the concepts presented herein to such detail. Additional adaptations and/or modifications may readily appear to persons having ordinary skill in the art, and, in its broader aspects, these adaptations and/or modifications may also be encompassed. Accordingly, departures may be made from the foregoing embodiments and/or examples without departing from the scope of the concepts presented herein, which scope is limited only by the following claims when appropriately construed.

What is claimed is:

1. An apparatus comprising:
a stator assembly;
a hub configured to rotate relative to the stator assembly, wherein the hub comprises a magnet radially outside the stator assembly; and
a fastener coupling radially inside the stator assembly and configured to secure a rotatable component.

2. The apparatus of claim 1, wherein the stator assembly is a portion of a fixed shaft motor.

3. The apparatus of claim 1, wherein the stator assembly is a portion of a rotating shaft motor.

4. The apparatus of claim 1, wherein the fastener coupling is configured for coupling of a fastener and a clamp.

5. The apparatus of claim 1, wherein a portion of the fastener coupling extends into a horizontal plane of the stator assembly.

6. The apparatus of claim 1, wherein the fastener coupling is more centrally located relative to the shaft of a motor assembly than the stator assembly.

7. The apparatus of claim 1, wherein the fastener coupling is configured for coupling of a clamp via a screw.

8. An apparatus comprising:
a stationary component including a stator assembly;
a rotatable component configured to rotate relative to the stationary component; and
a fastener coupled to the rotatable component radially inside the stator assembly.

9. The apparatus of claim 8, wherein the rotatable component is a portion of a fixed shaft motor.

10. The apparatus of claim 8, wherein the rotatable component is a portion of a rotating shaft motor.

11. The apparatus of claim 8, wherein the fastener is configured for coupling of a clamp.

12. The apparatus of claim 8, wherein the apparatus further comprises a first disk, a second disk, and a spacer between the first disk and the second disk.

13. The apparatus of claim 8, wherein a portion of the fastener extends into a horizontal plane of the stator assembly.

14. The apparatus of claim 8, wherein the fastener is radially inside of the stator assembly of the stationary component.

15. An apparatus comprising:
a stator assembly including stator windings;
a hub configured to rotate relative to the stator assembly; and
a fastener circle extending axially below a top surface of the stator assembly, wherein the fastener circle is radially inside the stator windings.

16. The apparatus of claim 15, wherein the stator assembly is radially inside of the hub.

17. The apparatus of claim 15, wherein the fastener circle is configured for coupling of a fastener and a clamp.

18. The apparatus of claim 15, wherein a portion of the fastener circle extends into a horizontal plane of the stator windings.

19. The apparatus of claim 15, wherein the fastener circle is configured for coupling of a clamp via a screw.

20. The apparatus of claim 15, wherein the fastener circle is radially between a seal and the stator assembly.
